(19) United States
(12) Patent Application Publication
(10) Pub. No.: US 2006/0112531 A1
(43) Pub. Date: Jun. 1, 2006

(54) Method for the exact assembly of a planetary gear unit

(76) Inventor: Alfred Skrabs, Sitterswald (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 11/264,967

(22) Filed: Nov. 2, 2005

(30) Foreign Application Priority Data
Nov. 30, 2004 (DE) 102004057576.2

(51) Int. Cl. B23P 11/00

(52) U.S. Cl. 29/428; 29/465

(57) ABSTRACT

A method for assembly of a planetary gear unit of a planetary transmission comprising a planetary gear, a planet shaft which, on a shoulder between a pivot and an outer wall, has an indented ring with a bearing situated between the planetary gear and the planet shaft and two thrust discs for the planetary gear. One tool is used which has two dies displaceable coaxially with the planet shaft. The method comprises the step of alignment and stretching the planetary gear unit to a medium positional zero play tolerance; positively fixing the aligned position on the guide plates of the planet carrier, and squeezing the pivot of the planet shaft to a predetermined measure. The planetary gear unit is aligned and stretched to medium positional zero play tolerance exclusively via the tool.

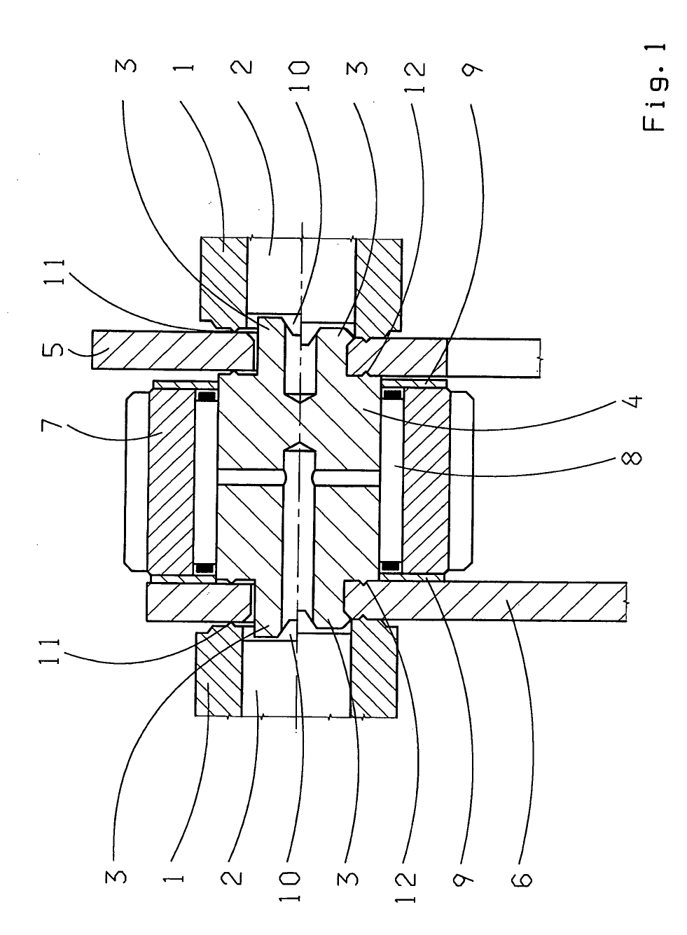

The invention concerns a method for the exact assembly of a planetary gear unit of a planetary transmission which comprises one planetary gear, one planet shaft and, inserted between the planet shaft and planetary gear, one bearing and two thrust plates.

Planetary gears are especially well suited to combine high ratios with a compact design. One essential part of a planetary gear is the planetary gear unit. In such a unit exact planet holes often have to be made with specially fine spindle machines, the holes having to be processed first by previous spindling and thereafter by finish spindling. It is very expensive to meet the tolerance requirements relative to axle inclination, axle off-set, diameter tolerance and uniform chord dimension. There great investment for the special fine spindle machines, the preparation of expensive tools for previous and finishing spindling, the employment of which takes considerable time, the same as the subsequently required deburring and subsequent testing step that follow. To ensure steps that guarantee high quality in the production, especially of automatic transmissions for motor vehicles, a high production cost is accordingly needed which disadvantageously has a negative effect in production expenses.

It is, therefore, sought to substitute a shaping operating cycle for said manufacturing steps.

The Applicant's EP 1 266 154 B1 has disclosed a method for exact assembly of a planetary gear unit of a planetary transmission within the scope of which the planetary gear unit, via the ring gear and the sun gear, is inserted, aligned and stretched in a tool to medium positional tolerance.

The tool has here two dies displaceable coaxially with the planet shaft and opposite to the two face ends thereof, the same as two jaws with indented rings circularly surrounding the dies and displaceable independently of the dies. The tool is first closed so that the indented rings abut on the guide plates and fix them; the tool is then further closed until the indented rings exert a constant pressure upon the outer sides of both guide plates, the dies being then pressed upon the ends of the planet shafts with a force such that these are swaged and thereby the appertaining guide plates are connected exactly and with positive fit with the planet shaft.

When aligning and stretching the planetary gear unit via the ring gear and the sun gear of the planetary set to medium positional tolerance, a bearing play relative to the planet shaft disadvantageously generates. This further requires an additional step of the method prior to the swaging step to form the planetary gear unit.

The problem on which this invention, based on the prior art, outlines a method for exact assembly of a planetary gear unit of a planetary transmission which comprises only one shaping operating cycle during which the bearing play in relation to the planet shaft is to be prevented.

This problem is solved with the features of claim 1. Other inventive developments and advantages result from the sub-claims.

Accordingly, proposed is a method for exact assembly of a planetary gear unit of a planetary transmission in which a tool is used which has two dies displaceable coaxially with the planet shaft and opposite to the two face ends thereof, the same as two jaws with indented rings circularly surrounding the dies and displaceable independently of the dies. The method comprising the step of aligning and stretching the planetary gear unit to medium positional zero play tolerance; next, the step of the positive fixing the aligned position on the guide plates of the planet carrier and the step of squeezing the pivot of the planet shaft to a predetermined measure in which the planetary gear unit is aligned and stretched to medium positional zero play tolerance exclusively via the tool.

To this end, the sides of the dies facing the planet shaft have each one centrally disposed peak tapering in direction of the planet shaft which can be positioned in the aperture defined by the pivot of the planet shaft for aligning and stretching the planetary gear unit.

The planetary gear unit comprises here one planetary gear, one planet shaft having pivots on the end faces and, radially observed, upon the shoulder between the pivot and the outer wall thereof, an indented ring, one bearing usually designed as a needle bearing and disposed between the planetary gear and the planet shaft and two thrust discs for the planetary gear.

The tool is then closed while by penetration of the indented rings of the jaws of the tool and of the planetary shaft, as result of the closing operation, the aligned position is fixed with positive fit on the guide plates of the planet carrier. After fixing one tool is further closed so that under constant pressure of the indented rings the dies squeeze the pivot of the planet shaft to a predetermined measure.

Thereby can be produced a positive fit and playfree connection of the planet shaft with the guide plates or a fixing of the aligned position to the guide plates can be obtained, a fine spindling of the planet holes being eliminated. During fine stamping of the guide plates the planet holes are stamped along with about 0.3 mm play to the planet shaft pivot.

The inventive idea easily produces a planetary gear unit where the production costs are lowered by integration in the tool actuation of the alignment and stretching of the planetary gear unit to medium positional zero play tolerance. A bearing play relative to the plane shaft is also extensively prevented.

In the planetary gear units produced applying the inventive method, part of the torque is assumed by the planet shaft and the planet carrier becomes more rigid. Depending on the torque the planet spiders can be advantageously eliminated according to the use at hand which results in further reduction of the production cost and of the weight.

In addition, the spacing is exactly preserved in the area of the planetary gears by the shoulder of the planet shaft; this means that—together with the improvement in quality achieved thereby—the guide plates to longer have to be flatly ground.

The invention is explained in detail herebelow by way of example with reference to the Figure enclosed which shows a sectional view of a planetary gear unit. In the Figure is illustrated to the left of the longitudinal axle of the planetary gear unit the situation prior to the swaging step and to the right of the longitudinal axle the situation after the swaging step.

According to the invention, the planetary gear unit, is comprised of one planetary gear 7, one planet shaft 4 having on both sides one pivot 3, one needle bearing 8 and a thrust disc 9, aligns and stretches the tool used simultaneously on both ends of the planet shaft 4 to medium positional zero play tolerance. In addition, the planet shaft 4, radially observed, has an indented ring 12 on the should between the pivot 3 and the other wall of the planet shaft 4.

The tool comprises two dies 2 disposably coaxially with the planet shaft 4 and displaceably opposite the two end faces thereof, the same as two jaws 1 with indented rings 11 circularly surrounding the dies 2 and axially displaceably independent of the dies.

The sides of the dies 2 facing the planet shaft 4 each have one peak 10, centrally situated and tapering in the direction of the planet shaft 4, which can be positioned in the aperture defined by the pivot 3 of the planet shaft 4 for aligning and stretching the planetary gear unit.

For the exact assembly of the planetary gear unit, this is aligned via the peaks 10 of the dies 2 introduced in the apertures defined by the pivot 3 of the planet shaft 4 and stretched by raising the pressure of the dies 2. The tool is then closed so that the indented rings 11 of the jaws 1 of the tool and indented rings 12 of the planet shaft 4, as result of the closing process, positively clamp the aligned position to the guide plates 5 or 6 of the planet carrier (not shown). After fixing, the tool is further closed so that the dies 2 squeeze the pivot 3 of the planet shaft 4 to a predetermined measure under constant pressure of the indented rings 11, 12.

It has proved of special advantage that the indented ring 11 of the jaw 1 of the tool have the same geometry as the indented ring 12 of the planet shaft 4 and be located opposite thereto so that, during the swaging step, the guide plates be not inadmissibly deformed outside the indented ring.

### REFERENCE NUMERALS

1 jaw
2 die
3 pivot
4 planet shaft
5 guide plate
6 guide plate
7 planetary gear
8 needle bearing
9 thrust disc
10 peak
11 indented ring
12 indented ring

1-3. (canceled)

4. A method for exact assembly of a planetary gear unit of a planetary transmission comprising:
one planetary gear,
one planet shaft which, on end faces thereof, has pivots and radially observed one indented ring on a shoulder between the pivot and the outer wall thereof,
one bearing situated between the planetary gear and the planet shaft and two thrust discs for the planetary gear, in which a tool is used which has two dies coaxially displaceable with the planet shaft and opposite to the two face ends thereof; and
two jaws with indented rings circularly surrounding the dies and displaceable independently of the dies; the method comprising the steps of:
aligning and stretching the planetary gear unit to medium positional tolerance to O-play,
positive fit fixing of the aligned position on the guide plates of the planet carrier; and
squeezing the pivot of the planet shaft to a predetermined measure, wherein the planetary gear unit is aligned and stretched to medium positional tolerance to O-play exclusively via the tool.

5. The method for exact assembly of a planetary gear unit of a planetary transmission according to claim 4, wherein the planetary gear unit is aligned and stretched by the fact that the sides of the dies (2) facing the planet shaft (5) have each one peak (10) which centrally situated and tapering in direction of the planet shaft (4) can be positioned for alignment in the aperture defined by the pivot (3) of the planet shaft (4), the stretching being accomplished by raising the pressure of the dies (2).

6. The method for exact assembly of a planetary gear unit of a planetary transmission according to claim 5, wherein after alignment and stretching of the planetary gear unit, the tool is closed so that the indented rings (11) of the jaws (1) of the tool and the indented rings (12) of the planet shaft (4), as result of the closing process, positively fix the aligned position on the guide plates (5, 6) of the planet carrier, the tool being further closed after the fixing so that under constant pressure of the indented rings the dies (2) squeeze the pivot (3) of the planet shaft (4) to a predetermined measure.

7. A method for assembling a planetary gear unit of a planetary transmission in which the planetary gear unit comprises
a planetary gear;
a planet shaft with two end faces and each end face has a pivot toward a center of the end face and an indented ring, the indented ring is located on a shoulder between the pivot and an outer surface of the planet shaft,
the planetary gear unit further has a bearing situated between the planetary gear and two thrust discs; and the method comprising the steps of:
aligning and stretching the planetary gear unit to a medium positional zero play tolerance;
fixing the guide plates of the planet carrier in a positive fit aligned position; and
squeezing the pivots of each of the two end faces of the planet shaft to a predetermined measurement such that the planetary gear unit is aligned and stretched to the medium positional zero play tolerance exclusively via a tool, and the tool has two dies each coaxially displaceable with the planet shaft and opposite to the two face ends, and two jaws with indented rings which circularly surround the dies and are independently displaceable with respect to the dies.

8. The method for assembling the planetary gear unit of the planetary transmission according to claim 7, further comprising the steps of aligning and stretching the planetary gear unit by sides of the two dies (2) facing the planet shaft (5) each having a peak (10) which is centrally situated and tapering in a direction of the planet shaft (4), the peaks can be positioned for alignment in an aperture defined by the pivot (3) of the planet shaft (4), and the stretching step being accomplished by increasing a pressure of the two dies (2).

9. The method for assembling the planetary gear unit of the planetary transmission according to claim 8, further comprising the step of closing the tool after the alignment and stretching of the planetary gear unit, so that indented rings (11) of the jaws (1) of the tool and indented rings (12) of the planet shaft (4), positively fixing the aligned position on the guide plates (5, 6) of the planet carrier, as result of the closing process, and further closing the tool, after the positively fixing step, so that the dies (2) squeeze the pivot (3) of the planet shaft (4) to a predetermined measurement under constant pressure of the indented rings.
